(19) United States
(12) Patent Application Publication
(10) Pub. No.: US 2025/0326041 A1
(43) Pub. Date: Oct. 23, 2025

(54) Machine Tool Device, Machine Tool and System

(71) Applicant: Robert Bosch GmbH, Stuttgart (DE)

(72) Inventors: Houman Ramezanian, Enntbaden (CH); Stefano Delfini, Bettlach (CH); Pascal Schnell, Bärschwil (CH)

(21) Appl. No.: 18/867,582

(22) PCT Filed: May 15, 2023
(86) PCT No.: PCT/EP2023/062905

§ 371 Date: Nov. 20, 2024

(30) Foreign Application Priority Data
May 23, 2022 (DE) 10 2022 205 094.0

(51) Int. Cl. B23D 45/16; B23D 61/10; B23Q 11/00

(52) U.S. Cl. CPC B23D 45/16; B23D 61/10; B23Q 11/0089

(57) ABSTRACT

A machine tool device, in particular circular saw device, includes (i) a clamping unit for fixing a tool, in particular a circular saw blade, (ii) a protective cover, which at least partly surrounds a tool holder region for the tool, (iii) an actuation unit for actuating the clamping unit, and (iv) a guard unit which blocks the actuation unit when the protective cover is at least partly open.

### PRIOR ART

A machine tool device comprising a clamping unit for fixing a tool, a protective cover, which at least partly surrounds a tool holder region for the tool, and an actuation unit for actuating the clamping unit has already been proposed.

### DISCLOSURE OF THE INVENTION

The invention relates to a machine tool device, in particular a circular saw device, comprising: a clamping unit for fixing a tool, in particular a circular saw blade; a protective cover, which at least partly surrounds a tool holder region for the tool; and an actuation unit for actuating the clamping unit.

It is proposed that the machine tool device comprises a guard unit which blocks the actuation unit when the protective cover is at least partly open. Advantageously, a machine tool device can be provided with a particularly high operating reliability. Advantageously, an unintended actuation of the actuation unit can be counteracted by releasing the tool from the clamping unit. Advantageously, the tool can be prevented from falling when the clamping unit is released. Advantageously, a particularly low risk of injury for a user can be achieved. Advantageously, the tool can be changed quickly and easily while providing particularly high user safety. The guard unit is preferably mechanically formed. Preferably, the actuation unit is blocked or released by the guard unit, in particular automatically, depending on a protective cover position of the protective cover. The guard unit can preferably be actuated depending on the protective cover position, in particular automatically. In particular, the guard unit releases an actuation of the actuation unit when the protective cover is closed, preferably automatically. The protective cover position in particular indicates whether the protective cover is at least partly open or closed. Alternatively, it is also conceivable that the guard unit is at least partly electrically formed. For example, it is conceivable that the guard unit comprises a detection unit for detecting a protective cover position. For example, the detection unit may comprise a mechanical sensor, an optical sensor, or another sensor that appears useful to a person skilled in the art for detecting the protective cover position. It is conceivable that the guard unit comprises a control unit, which is in particular configured to evaluate a signal of the detection unit and, as a function thereof, block or release the actuation unit. In particular, the control unit comprises at least one processor and one memory element, as well as an operating program stored on the memory element. The memory element is preferably designed as a digital storage medium, e.g., a hard disk or the like. It is also conceivable that the control unit of the guard unit may be formed by a control unit of the machine tool.

The clamping unit can in particular be operated without tools, preferably by means of the actuation unit. The clamping device is preferably fixed, in particular non-rotatable, on a machine tool, in particular on an output spindle of an output unit of the machine tool. Alternatively, it is conceivable that the clamping unit is releasably arranged on the machine tool, in particular on the output spindle. The clamping device is preferably intended for fastening the tool to the machine tool device, in particular without tools. The term “intended” should be understood to mean specially furnished, specially designed, and/or specially equipped. An object being “intended” for a specific function is understood to mean that the object fulfills and/or performs this specific function in at least one application and/or operating state. Preferably, the tool can be driven to rotate or oscillate in a state in which it is fixed to the clamping unit, in particular about a rotational axis of a connection interface of the tool. Preferably, the tool can be driven by the output spindle, preferably rotating or oscillating, in particular in a state in which it is fixed to the machine tool by means of the clamping unit. The clamping unit, in particular when viewed in a plane extending at least substantially perpendicular to an output axis of the output spindle, has an outer contour designed to correspond with a contour of the connection interface. The term “substantially perpendicular” can be understood to mean an orientation of a direction relative to a reference direction, whereby, in particular viewed in a projection plane, the direction and the reference direction enclose an angle of 90° and the angle has a maximum deviation of in particular less than 8°, advantageously less than 5°, and particularly advantageously less than 2°. The contour of the connection interface results in particular from a path of an inner boundary contour and an outer boundary contour of the connection interface. The output axis preferably runs in a state in which the tool is fixed to the clamping unit at least substantially parallel to the rotational axis of the connection interface.

Preferably, the output unit is intended to transmit a rotational and/or oscillating movement about the output axis to the tool fixed to the output unit by means of the clamping unit. Preferably, the output unit is effectively connected to a drive unit of the machine tool in a manner already known to a person skilled in the art, in particular via at least one drive pinion of the drive unit. In particular, the output unit comprises at least one sleeve and/or at least one hollow shaft, in particular a hollow spindle, which forms the output spindle. The rotational and/or oscillating movement of the output unit can preferably be generated as a result of interaction between the output unit and the drive unit of the machine tool, which comprises at least one electric motor.

In a further aspect of the invention, which can be considered in particular on its own as well as in connection with other aspects of the invention, it is proposed that the actuation unit comprises an operating element, which can be at least partly moved along the protective cover for actuation. The design of the machine tool device according to the invention advantageously enables a tool to be released particularly easily and quickly from a state in which it is fixed to the clamping unit. Advantageously, a tool can be changed in a particularly convenient and time-saving manner. Advantageously, a particularly fast work flow can be ensured. Advantageously, particularly space-saving and at the same time safe actuation of the operating element can be achieved. Advantageously, an actuation unit, in particular an operating element, can be provided, which can be operated in a particularly compact manner. Thus, damage to the actuation unit, in particular the operating element, can advantageously be counteracted in a particularly simple and effective manner. Advantageously, a particularly ergonomic actuation of the actuation unit, in particular the operating element, can be achieved. Advantageously, an operator injury may be prevented when operating the actuation unit. The operating element is in particular intended for manual actuation by a user. Preferably, the operating element can be moved along the protective cover by a rotation about an operating element rotational axis. Preferably, the operating element can be moved for actuation at least substantially parallel to a surface, in particular the outer surface, of the protective cover. “Substantially parallel” is to be understood here in particular to mean an orientation of a direction relative to a reference direction, in particular in a plane, wherein the direction has a deviation relative to the reference direction that is in particular less than 8°, advantageously less than 5° and particularly advantageously less than 2°. Preferably, the actuation unit comprises at least one lever arm by means of which the operating element in particular can be moved about the operating element rotational axis. The operating element is preferably rotatably mounted on a portion of the protective cover, preferably by means of the lever arm. It is alternatively also conceivable that the operating element, in particular the lever arm, can be moved, preferably rotatably, mounted on a housing element of the machine tool, which is in particular different from the protective cover, or the like. The operating element is preferably arranged spaced apart from the protective cover. The operating element can be moved at least partly along the protective cover, preferably at a consistent distance from the protective cover, for actuation. However, it is alternatively also conceivable that the operating element abuts the protective cover, preferably through the protective cover, in particular the surface of the protective cover facing the operating element can be guided during a movement along the protective cover. Preferably, only one operating element is to be actuated to release the tool from a state in which it is fixed to the clamping unit.

It is further proposed that the operating element can be moved about an operating element rotational axis, wherein a movement of the operating element about the operating element rotational axis can generate a movement of an actuating element of the clamping unit which runs at least substantially parallel to the operating element rotational axis. In particular, the operating element rotational axis runs at least substantially parallel to the output axis of the output spindle and/or the rotational axis of the connection interface of the tool in a state in which it is fixed to the clamping unit. A movement of the operating element for actuating the clamping unit runs preferably in a plane, which is at least substantially perpendicular to the output axis and/or the rotational axis of the tool in a state in which it is fixed to the clamping unit. For example, the actuating element is configured as a bolt, a pin, or another actuating element that appears useful to a person skilled in the art. The clamping unit preferably comprises at least two states, in particular a released state and a fastened state. In the released state, the tool can preferably be detached from the clamping unit, in particular from a mounting position on the clamping unit, or can be arranged on the clamping unit in the mounting position. In the fastened state, the tool is fixed to the clamping unit in a state arranged on the clamping unit, in particular in the mounting position. By a movement of the actuating element of the clamping unit, the clamping unit can in particular be transferred from the fastened state to the released state or from the released state to the fastened state. Advantageously, a particularly ergonomically operable arrangement of the actuation unit can be realized. A particularly high level of operating convenience can be achieved in an advantageous manner.

Furthermore, it is proposed that the actuation unit comprises a ramp-shaped actuation means. The actuating means is in particular intended to cooperate with the actuating element of the clamping unit for actuating the clamping unit. Preferably, the actuating means is intended for transferring the movement of the operating element, in particular via the lever arm, to the actuating element of the clamping unit. Preferably, the actuation means is arranged on the lever arm. The actuation means is preferably connected to the operating element via the lever arm. Preferably, the actuating means is fastened to the lever arm, in particular in a rotationally fixed manner, for example by means of a screw connection, a latching connection, or the like. It is conceivable that the lever arm may be formed in one piece or in multiple pieces. Alternatively, it is conceivable that the actuation means is at least partly integrally formed with the lever arm. The text “at least one unit or object”, in particular the lever arm, and at least one further unit or object are designed to be “at least partially integral with one another” is in particular understood to mean that at least one element of the unit or object is designed to be integral with at least one further element of the further unit or object, in particular the lever arm. The term “integral” is to be understood in particular to mean at least a materially bonded connection, for example, by a welding process, an adhesive bonding process, an injection molding process and/or another process that appears to the person skilled in the art to be reasonable, and/or advantageously formed in one piece, for example, by production from a casting and/or by production in a single-component or multi-component injection molding process and advantageously from a single blank. The operating element is preferably fastened to the lever arm, in particular in a rotationally fixed manner, for example by means of a screw connection, a latching connection, or the like. Alternatively, it is also conceivable that the actuating element is at least partly integrally formed with the lever arm. In particular, the actuation means and the operating element are arranged at opposite ends of the lever arm. Advantageously, a movement of the operating element along the protective cover can be transferred particularly easily into a movement for actuating the clamping unit. Advantageously, a particularly uniform release of the clamping unit can be achieved.

In addition, it is proposed that the actuation unit comprises an actuation means, in particular the aforementioned one, which at least partly surrounds the operating element rotational axis. Preferably, the actuation means surrounds the operating element rotational axis in a maximum angular range of 75°. Preferably, the angular range in which the actuation means surrounds the operating element rotational axis is at least 20°. Advantageously, particularly convenient and uniform operation of the clamping unit can be realized.

Furthermore, it is proposed that the clamping unit can be released by an actuation path of the operating element along the protective cover of at least 40°, in particular about the operating element rotational axis. Preferably, the clamping unit can be released along the protective cover by an actuation path of the operating element of at least 40° starting from an end position of the operating element in the fastened state of the clamping unit. Alternatively, however, it is also conceivable that the actuation unit is configured such that the actuation path, in particular for releasing the clamping unit, is preferably less than 40° starting from the end position of the operating element in the fastened state of the clamping unit. Preferably, an actuation path of the operating element starting from an end position of the operating element in the released state of the clamping unit for generating the fastened state is smaller than the actuation path for generating the released state starting from the end position of the operating element in the fastened state of the clamping unit. Advantageously, the clamping unit can be released particularly easily and quickly, wherein, in particular simultaneously, an unintended release of the clamping unit can be counteracted. Advantageously, a tool can be changed particularly quickly and conveniently. Advantageously, a particularly high operating comfort can be achieved when releasing the clamping unit.

In addition, it is proposed that an actuating path of the operating element along the protective cover for operating the clamping unit, in particular the one already mentioned, is a maximum of 75°, in particular about the operating element rotational axis. Preferably, the actuation path of the operating element along the protective cover for releasing the clamping unit is a maximum of 75°, in particular about the operating element rotational axis, preferably starting from the end position of the operating element in the fastened state of the clamping unit. In an alternative embodiment of the actuation unit, it is also conceivable that the actuation path of the operating element along the protective cover for actuating the clamping unit, in particular for releasing the clamping unit from the fastened state, is more than 75°, in particular about the operating element rotational axis, for example at a maximum of 90°, preferably a maximum of 135°, particularly preferably a maximum of 180°. Advantageously, the clamping unit can be released particularly conveniently and quickly. Advantageously, a space requirement for actuating, in particular releasing, the clamping unit can be kept particularly low. A particularly compact battery actuation unit can be provided in an advantageous manner.

It is further proposed that the actuation path has an idle travel of at least 20°, in particular about the operating element rotational axis. In particular, the idle travel runs starting from the end position of the operating element in the fastened state of the clamping unit. In particular, the actuation unit, preferably the actuating means, only exerts an actuating effect, in particular an actuating force, on the clamping unit, in particular the actuating element of the clamping unit, in a state of the operating element arranged outside the idle travel. The clamping unit, in particular the actuating element, is preferably free from an actuating effect, in particular an actuating force, by the actuation unit, in particular the actuating means of the actuation unit, in a state of the operating element arranged within the idle travel. It is conceivable that the actuating means of the actuation unit is arranged in a state of the operating element spaced apart from the actuating element of the clamping unit in a state arranged within the idle travel. Alternatively, however, it is also conceivable that the actuating means of the actuation unit abuts the actuating element of the clamping unit in a state of the operating element arranged within the idle travel. Preferably, the actuating means, in particular a force transfer surface of the actuating element, abuts the actuating element of the clamping unit at least in a state arranged outside of the idle travel. Preferably, the actuating means, in particular the force transfer surface of the actuating element, applies a force to the actuating element of the clamping unit, in particular to release the clamping unit, at least in a state of the actuating element arranged outside the idle travel. Advantageously, an unintended release of the clamping unit by the actuation unit can be counteracted in a simple and effective manner. A particularly high level of occupational safety can be achieved.

Furthermore, it is proposed that the operating element is arranged in the radial direction on a side of the protective cover facing away from the tool holder region. The radial direction relates in particular to the operating element rotational axis. Advantageously, an actuation unit can be provided with a particularly favorable arrangement of the operating element in terms of operating safety. Advantageously, the operator can be prevented from reaching into the tool holder region, in particular into the tool. Advantageously, a risk of injury when operating the operating element can be kept particularly low. Advantageously, a particularly convenient operation of the operating element can be achieved.

In addition, it is proposed that the operating element is arranged in a fastened state, in particular the previously mentioned one, of the clamping unit on a side of the protective cover facing away from an operating side. Preferably, an operator is located at least in an operating state on the operating side. A main handle of the machine tool, in particular the machine tool device, or the like, is preferably arranged on the operating side. Advantageously, the arrangement of the operating element according to the invention can counteract an unintended actuation, in particular release, of the clamping unit particularly easily and effectively at least in one operating state.

Furthermore, it is proposed that the guard unit comprises a locking element, wherein a closing of the protective cover moves the locking element to an unlocked position. For example, the locking element is configured as a pin, a hook, a ramp-shaped element, or another locking element that appears useful to a person skilled in the art. Preferably, the actuation unit can be actuated in the unlocked position of the locking element. Preferably, the operating element can be moved along the protective cover in the unlocked position of the locking element. In particular, the actuation unit, preferably the operating element, is free of engagement, in particular the application of force, by the guard unit, preferably the locking element, in the unlocked position of the locking element. Preferably, the guard unit can be actuated by a movement of at least a portion of the protective cover. In particular, the locking element can be moved by a movement of the at least portion of the protective cover. Preferably, the locking element can be moved from an unlocked state to a locked state and/or from the locked state to the unlocked state by a movement of the at least one portion of the guard unit. In the unlocked state, the locking element is in particular in the unlocked position. In the locked state, the locking element is in particular in a locked position. Preferably, the locking element can only be moved to the unlocked state in a closed state of the protective cover. Preferably, the guard unit is designed such that the locking element automatically moves into the locked state when the protective cover is in the open state, for example by means of a gravity-controlled mechanism, by means of a spring element or the like. Advantageously, a closing of the protective cover can be used to unlock the guard unit. Advantageously, the actuation unit can be actuated automatically by closing the protective cover. A particularly high level of operating convenience can be achieved in an advantageous manner.

In addition, it is proposed that the guard unit comprises a locking element configured as a pin, in particular the aforementioned one, which engages the actuation unit when the protective cover is at least partly opened. Preferably, the locking element acts on the lever arm of the actuation unit when the protective cover is at least partly opened. It is also conceivable that the lever arm has a recess, a notch, or the like, in which the locking element is arranged in the locked state. In particular, the locking element blocks the movement of the operating element along the protective cover when the protective cover is at least partly open. In the locked state, the locking element blocks a movement, in particular a rotation, of the lever arm, in particular about the operating element rotational axis. Advantageously, actuation of the clamping unit by means of the actuation unit can be counteracted in a particularly effective and constructively simple manner and thus also prevent the tool falling out when the protective is at least partly opened.

Furthermore, it is proposed that the guard unit comprises a locking element, in particular the aforementioned one, which can be moved by a rotation about a locking element rotational axis to an unlocked position, in particular the aforementioned one, or to a locked position, in particular the aforementioned one. For example, the guard unit, in particular the locking element, is rotatably supported on a portion of the protective cover, on the housing element of the machine tool, or on a further housing element of the machine tool. A particularly space-saving and smooth-running guard unit can be provided in an advantageous manner.

Furthermore, it is proposed that the rotation of the locking element can be generated by a movement of at least a portion of the protective cover. Preferably, the protective cover, in particular the at least one portion of the protective cover, is arranged relative to the locking element, such that the at least one portion abuts the guard unit when closing the protective cover and moves the locking element to the unlocked position. Alternatively, it is also conceivable that the guard unit, in particular at least the locking element, is mechanically, in particular operatively, preferably directly, connected to the protective cover, in particular the at least one portion of the protective cover, irrespective of the protective cover position. Advantageously, a particularly simple and convenient actuation of the guard unit, which is advantageous with regard to operating safety, can be achieved.

It is further proposed that the protective cover comprises at least one upper part of the protective cover and one lower part of the protective cover, which is rotatably arranged relative to the upper part of the protective cover about a protective cover rotational axis. The upper part of the protective cover is preferably fixedly connected, in particular in a rotationally fixed manner, to the housing element, the further housing element or an additional housing element of the machine tool. The operating element can preferably be moved along the upper part of the protective cover for actuating the clamping unit. It is conceivable that the upper part of the protective cover comprises a ramp, or the like, along which the operating element can be moved for actuating the clamping unit. The ramp is in particular mounted on a base body of the upper part of the protective cover. It is conceivable that the ramp is configured separately to the base body and is fastened to the base body, for example by means of a screw connection, a latching connection or the like, or that the ramp is configured integrally with the base body. However, it is also conceivable that the upper part of the protective cover is configured free of a ramp. The upper part of the protective cover and the lower part of the protective cover at least partly surround the tool holder region. The lower part of the protective cover can in particular be pivoted between the open state of the protective cover and the closed state of the protective cover relative to the upper part of the protective cover. The guard unit can preferably be actuated by a cooperation, in particular a movement, of the lower part of the protective cover. Preferably, the lower part of the protective cover moves the locking element to the unlocked state when the protective cover is closed. Advantageously, the guard unit can be actuated by a relative movement of the lower part of the protective cover to the upper part of the protective cover, in particular automatically. A particularly high level of operating convenience can be achieved in an advantageous manner.

It is also proposed that the protective cover rotational axis is spaced apart from and arranged at least substantially parallel to the operating element rotational axis. Alternatively, it is also conceivable that the protective cover rotational axis corresponds to the operating element rotational axis. Advantageously, a space requirement of the actuation unit and the protective cover can be kept particularly compact.

It is also proposed that the protective cover rotational axis is spaced apart from and arranged at least substantially parallel to the locking element rotational axis. A particularly favorable force action chain between the protective cover and the guard unit can advantageously be achieved for actuating the guard unit. Advantageously, the guard unit can be actuated with a particularly low amount of force.

It is also proposed that the locking element rotational axis is spaced apart from and arranged at least substantially parallel to the operating element rotational axis. Advantageously, a space requirement of the actuation unit and the guard unit can be kept particularly compact. Advantageously, a particularly favorable force action chain may be achieved between the locking unit and the actuation unit for locking and/or unlocking the actuation unit.

Furthermore, it is proposed that the protective cover at least partly surrounds the guard unit. Preferably, the guard unit, in particular at least the locking element, is arranged on a side of the protective cover facing the tool holder region. Preferably, the guard unit, in particular at least the locking element, is arranged between the upper part of the protective cover and the lower part of the protective cover. Advantageously, the guard unit can be protected from damage, in particular from direct impacts. By the arrangement of the guard unit according to the invention, an unintended unlocking of the guard unit can be countered particularly easily and effectively.

Furthermore, a machine tool, in particular circular saw device, with a tool interface device according to the invention is proposed. The machine tool is preferably designed as a portable machine tool, in particular as a hand-held power tool. The term “portable machine tool” is understood in this context to mean a machine tool for machining workpieces and able to be transported by an operator without the need for a transport machine. In particular, the portable machine tool has a mass that is less than 40 kg, preferably less than 10 kg, and more preferably less than 5 kg. Preferably, the machine tool is configured as a circular saw device. However, it is also conceivable that the machine tool has another configuration that would appear useful to a person skilled in the art, such as a configuration as an angle grinder, as a circular table saw, as an oscillating machine tool, as a grinding machine or the like. The embodiment according to the invention can advantageously provide a machine tool that enables particularly fast releasing and changing of tools on the machine tool. A particularly efficient work flow can be achieved in an advantageous manner.

Furthermore, a system with a tool, in particular circular saw device, and with a tool machine tool according to the invention is proposed. As an alternative to a design as a circular saw blade, it is also conceivable that the tool is designed as a grinding disc, a cutting disc, a polishing disc, or any other tool that would appear useful to a person skilled in the art. Advantageously, a system may be provided that allows for particularly fast and straightforward release of the tool from the machine tool. Advantageously, tools can be replaced particularly quickly and conveniently. Particularly efficient working with the machine tool can advantageously be realized.

The machine tool device according to the invention, the machine tool according to the invention, and/or the system according to the invention should not thereby be limited to the application and embodiment described above. In particular, the machine tool device according to the invention, the machine tool according to the invention and/or the system according to the invention can/can have a number of individual elements, components and units that differs from a number specified herein in order to fulfill a mode of operation described herein. Moreover, regarding the ranges of values indicated in this disclosure, values lying within the limits specified hereinabove are also intended to be considered as disclosed and usable as desired.

### DRAWINGS

Further advantages follow from the description of the drawings hereinafter. An exemplary embodiment of the invention is shown in the drawing. The drawings, the description, and the claims contain numerous features in combination. A person skilled in the art will appropriately also consider the features individually and combine them into additional advantageous combinations.

Shown are:

FIG. 1 a schematic view of a system according to the invention with a machine tool according to the invention and a tool arranged on the machine tool,

FIG. 2 a perspective exploded view of a machine tool device according to the invention of the machine tool according to the invention,

FIG. 3 a perspective cross-sectional view through the machine tool of FIG. 1

FIG. 4 a schematic front view of a portion of the machine tool according to the invention without the tool in an unlocked state of a guard unit of the machine tool device according to the invention,

FIG. 5 a schematic perspective rear view of a portion of the machine tool according to the invention with the tool in the unlocked state of the guard unit,

FIG. 6 a schematic front view of the portion of the machine tool according to the invention without the tool in a locked state of the guard unit, and

FIG. 7 a schematic perspective rear view of a portion of the machine tool according to the invention with the tool in the locked state of the guard unit.

### DESCRIPTION OF THE EMBODIMENT EXAMPLE

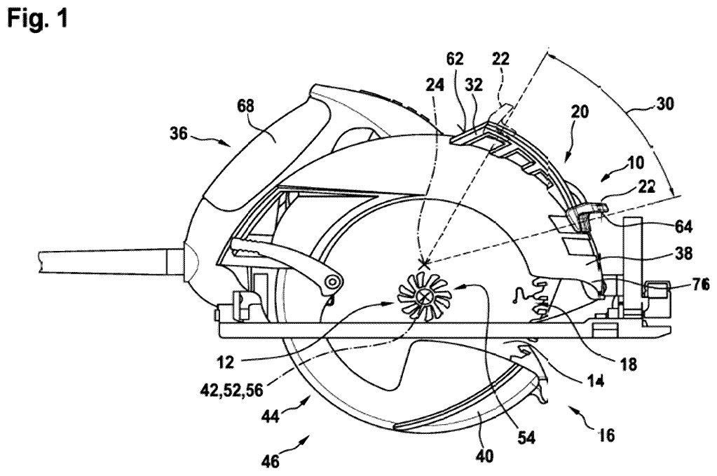

FIG. 1 shows a system 46 having a tool 14 and having a machine tool 44. The machine tool 44 is preferably designed as a portable machine tool, in particular as a hand-held power tool. The machine tool 44 is configured as a circular saw blade. However, it is also conceivable that the machine tool 44 has another configuration that would appear useful to a person skilled in the art, such as a configuration as an angle grinder, as a circular table saw, as an oscillating machine tool, as a grinding machine or the like. The tool 14 is configured as a circular saw blade. Alternatively, it is also conceivable that the tool 14 is designed as a grinding disc, a cutting disc, a polishing disc, or any other tool 14 that would appear useful to a person skilled in the art.

The machine tool 44 has a machine tool device 10. The machine tool device 10 has a clamping unit 12 for fixing the tool 14. The clamping unit 12 can be operated without tools. The machine tool device 10 comprises an actuation unit 20 for actuation of the clamping unit 12, in particular without tools. The clamping unit 12 is fixed, in particular non-rotatable, on the machine tool 44, in particular on an output spindle of an output unit of the machine tool 44. Alternatively, it is conceivable that the clamping unit 12 is releasably arranged on the machine tool 44, in particular on the output spindle. The clamping device 12 is preferably intended for fastening the tool 14 to the machine tool device 10, in particular without tools. The tool 14 can be driven to rotate or oscillate in a state in which it is fixed to the clamping unit 12, in particular about a rotational axis 52 of a connection interface 54 of the tool 14. The tool 14 can be driven by the output spindle, preferably rotating or oscillating, in a state in which it is fixed to the machine tool 44 by means of the clamping unit 12. The clamping unit 12, in particular when viewed in a plane extending at least substantially perpendicular to an output axis 56 of the output spindle, has an outer contour designed to correspond with a contour of the connection interface 54. The contour of the connection interface 54 results from a path of an inner boundary contour and an outer boundary contour of the connection interface 54. The output axis 56 runs in a state in which the tool 14 is fixed to the clamping unit 12 at least substantially parallel to the rotational axis 52 of the connection interface 54. In a state in which the tool 14 is fixed to the clamping unit 12, the output axis 56 corresponds to the rotational axis 52 of the connection interface 54.

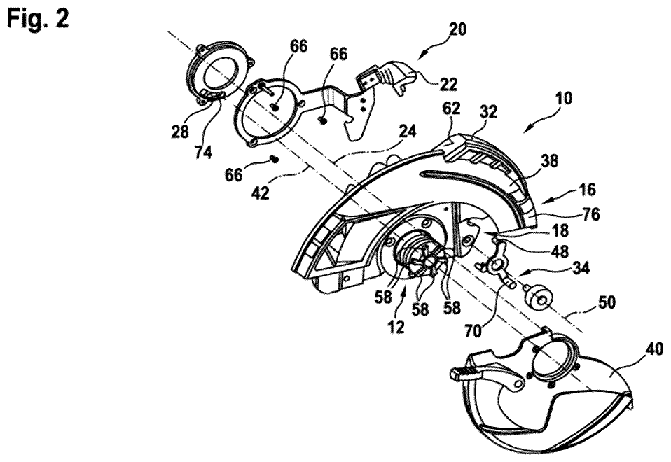

The clamping unit 12 is configured as a quick clamping device here, as it is disclosed, for example in WO 2021/130026 A1, but with six retaining wings corresponding to the connection interface 54 (see also FIG. 2). The disclosure content of WO 2021/130026 A1 with regard to the quick clamping device disclosed therein is to be regarded in particular as part of the present description with regard to the embodiment of the clamping unit 12. However, it is alternatively also conceivable that the clamping unit 12 is configured with four retaining wings according to the quick clamping device from WO 2021/130026 A1, is configured as a quick clamping device as disclosed, for example in DE 10 2017 213 669 A1, or is configured as another quick clamping device that appears to be useful to a person skilled in the art.

The output unit is intended to transmit a rotational and/or oscillating movement about the output axis 56 to the tool 14 fixed to the output unit by means of the clamping unit 12. The output unit is effectively connected to a drive unit of the machine tool 44 in a manner already known to a person skilled in the art, in particular via at least one drive pinion of the drive unit. In particular, the output unit comprises at least one sleeve and/or at least one hollow shaft, in particular a hollow spindle, which forms the output spindle. The rotational and/or oscillating movement of the output unit can preferably be generated as a result of interaction between the output unit and the drive unit of the machine tool 44, which comprises at least one electric motor.

The machine tool device 10 comprises a protective cover 16, which at least partly surrounds a tool holder region 18 for the tool 14. The actuation unit 20 has an operating element 22 which can be moved at least partly along the protective cover 16 for actuation. The operating element 22 is intended for manual actuation by a user. The operating element 22 can be moved about an operating element rotational axis 24. The operating element 22 can be moved along the protective cover 16 by a rotation about the operating element rotational axis 24. The operating element 22 can be moved for actuation at least substantially parallel to a surface 58, in particular the outer surface, of the protective cover 16.

The actuation unit 20 comprises at least one lever arm 60. By means of the lever arm 60, the operating element 22 can be moved about the operating element rotational axis 24. The operating element 22 is rotatably mounted on a portion of the protective cover 16, in particular on an upper part of the protective cover 38 of the protective cover 16, in particular by means of the lever arm 60. The operating element 22 can be moved along the upper part of the protective cover 38 for actuating the clamping unit 12. It is alternatively also conceivable that the operating element 22, in particular the lever arm 60, is movably, preferably rotatably, mounted on a housing element of the machine tool 44, which is in particular different from the protective cover 16, or the like. The operating element 22 is arranged spaced apart from the protective cover 16, in particular the upper part of the protective cover 38. The operating element 22 can be moved for actuation at a consistent distance from the protective cover 16, in particular the upper part of the protective cover 38, at least partly along the protective cover 16, in particular the upper part of the protective cover 38. However, it is alternatively also conceivable that the operating element 22 abuts the protective cover 16, in particular through the protective cover 16, preferably the surface 58 of the protective cover 16 facing the operating element 22 can be guided during a movement along the protective cover 16, in particular the upper part of the protective cover 38. Only one operating element 22 is to be actuated to release the tool 14 from a state in which it is fixed to the clamping unit 12.

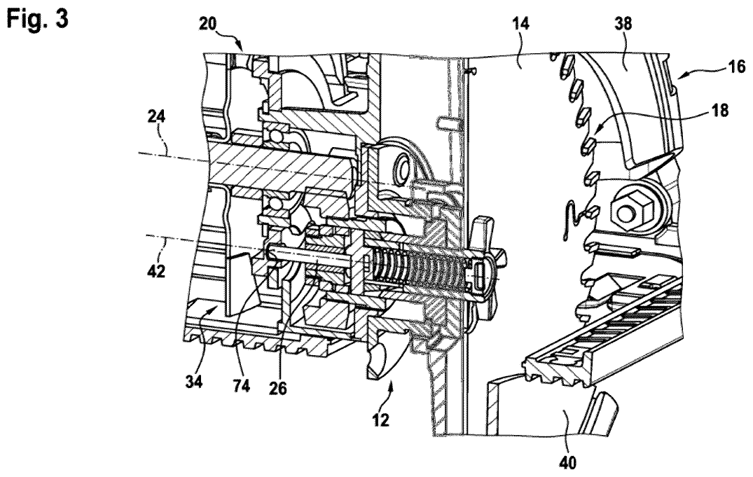

A movement of the operating element 22 about the operating element rotation axis 24 can generate a movement of an actuating element 26 of the clamping unit 12 that is at least substantially parallel to the operating element rotational axis 24 (see also FIG. 3). The operating element rotational axis 24 runs at least substantially parallel to the output axis 56 of the output spindle and/or the rotational axis 52 of the connection interface 54 of the tool 14 in a state in which it is fixed to the clamping unit 12. A movement of the operating element 22 for actuating the clamping unit 12 runs in a plane, which is at least substantially perpendicular to the output axis 56 and/or the rotational axis 52 of the tool 14 in a state in which it is fixed to the clamping unit 12.

For example, the actuating element 26 is configured as a bolt, a pin, or another actuating element 26 that appears useful to a person skilled in the art. The clamping unit 12 comprises at least two states, in particular a released state and a fastened state. In the released state, the tool 14 can be detached from the clamping unit 12, in particular from a mounting position on the clamping unit 12, or can be arranged on the clamping unit 12 in the mounting position. In the fastened state of the clamping unit 12, the tool 14 is fixed to the clamping unit 12 in a state arranged on the clamping unit 12, in particular in the mounting position. Through a movement of the actuating element 26 of the clamping unit 12, the clamping unit 12 can be transferred from the fastened state to the released state or from the released state to the fastened state.

In FIG. 1, the actuation unit 20, in particular the operating element 22, is shown in two different positions. The solid line representation of the operating element 22 corresponds to the fastened state of the clamping unit 12, wherein the operating element 22 is located in an end position of the operating element 22 in the fastened state of the clamping unit 12. The dashed line representation of the operating element 22 corresponds to the released state of the clamping unit 12, wherein the operating element 22 is located in an end position of the operating element 22 in the released state of the clamping unit 12. It is additionally conceivable that the actuation unit 20 comprises a spring element that impinges a force on the operating element 22 towards the end position of the operating element 22 in the fastened state of the clamping unit 12.

The actuation unit 20 comprises a ramp-shaped actuation means 28. The actuating means 28 is intended to cooperate with the actuating element 26 of the clamping unit 12 for actuating the clamping unit 12. The actuating means 28 is intended to transfer the movement of the operating element 22, in particular via the lever arm 60, to the actuating element 26 of the clamping unit 12. The actuation means 28 is arranged on the lever arm 60. The actuation means 28 is connected to the operating element 22 via the lever arm 60. The lever arm 60 is formed in two parts. Alternatively, however, it is also conceivable that the lever arm 60 is formed in one piece or is formed by more than two parts. The actuating means 28 are fixed to the lever arm 60 by means of bolts 66. Alternatively, it is also conceivable that the actuating means 28 are fixed to the lever arm 60 by means of a latching connection, a rivet connection, or the like, in particular in a rotationally fixed manner, or that the actuating means 28 is at least partly integrally formed with the lever arm 60. In particular, the actuating means 28 and the operating element 22 are arranged at opposite ends of the lever arm 60.

The actuating means 28 at least partly surrounds the operating element rotational axis 24. The actuation means 28 surround the operating element rotational axis 24 in a maximum angular range of 75°. The angular range in which the actuation means 28 surround the operating element rotational axis 24 is at least 20°.

The clamping unit 12 can be released by way of an actuation path 30 of the operating element 22 along the protective cover 16 of at least 40°. The clamping unit 12 can be released along the protective cover 16, in particular the upper part of the protective cover 38, by an actuation path 30 of the operating element 22 of at least 40° starting from the end position of the operating element 22 in the fastened state of the clamping unit 12. Alternatively, however, it is also conceivable that the actuation unit 20 is configured such that the actuation path 30, in particular for releasing the clamping unit 12, is less than 40° starting from the end position of the operating element 22 in the fastened state of the clamping unit 12. An actuation path of the operating element 22 starting from an end position of the operating element 22 in the released state of the clamping unit 12 for generating the fastened state is in particular smaller than the actuation path 30 for generating the released state starting from the end position of the operating element 22 in the fastened state of the clamping unit 12.

The actuation path 30 of the operating element 22 along the protective cover 16 for actuating the clamping unit 12 is a maximum of 75°. The actuation path 30 of the operating element 22 along the protective cover 16, in particular the upper part of the protective cover 38, for releasing the clamping unit 12 is a maximum of 75°, in particular about the operating element axis of rotation 24, preferably starting from the end position of the operating element 22 in the fastened state of the clamping unit 12. Alternatively, it is also conceivable that the actuation path 30 of the operating element 22 along the protective cover 16 for actuating the clamping unit 12, in particular for releasing the clamping unit 12 from the fastened state, is more than 75°, in particular about the operating element rotation axis 24, for example at a maximum of 90°, preferably a maximum of 135°, particularly preferably a maximum of 180°.

The actuation path 30 has an idle travel of at least 20°. The idle travel runs starting from the end position of the operating element 22 in the fastened state of the clamping unit 12. The actuation unit 20, in particular the actuating means 28, only exerts an actuating effect, in particular an actuating force, on the clamping unit 12, in particular the actuating element 26 of the clamping unit 12, in a state of the operating element 22 arranged outside the idle travel. The clamping unit 12, in particular the actuating element 26, is free from an actuating effect, in particular an actuating force, by the actuation unit 20, in particular the actuating means 28 of the actuation unit 20, in a state of the operating element 22 arranged within the idle travel. The actuating means 28, in particular a force transfer surface 74 of the actuating element 26, imparts a force on the actuating element 26 of the clamping unit 12 in a state of the operating element 22 arranged outside of the idle travel.

The operating element 22 is arranged in the radial direction on a side of the protective cover 16 facing away from the tool holder region 18. The radial direction relates in particular to the operating element rotational axis 24. The operating element 22 is arranged in a fastened state of the clamping unit 12 on a side of the protective cover 16 facing away from an operating side 36. An operator is located at least on the operating side 36 when the machine tool 44 is operating properly. A main handle 68 of the machine tool 44, in particular the machine tool device 10, is arranged on the operating side 36.

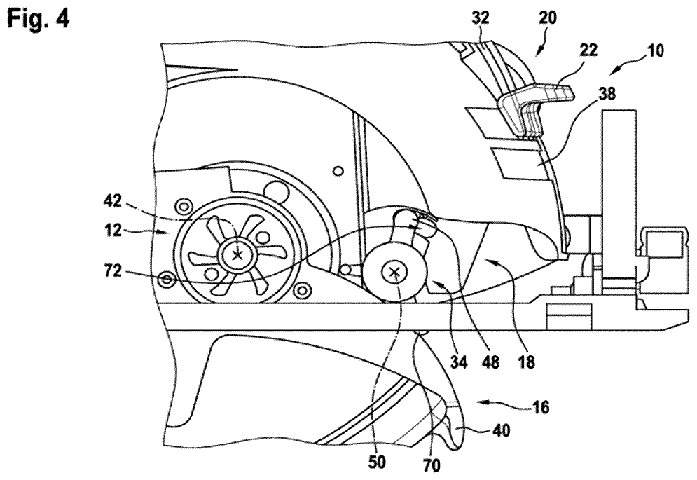

The machine tool device 10 comprises at least one guard unit 34, which blocks the actuation unit 20 when the protective cover 16 at least partly opened (see FIGS. 4 to 7). The guard unit 34 is mechanically formed. The actuation unit 20 is blocked or released by the guard unit 34, in particular automatically, depending on a protective cover position of the protective cover 16, in particular a lower part of the protective cover 40 relative to the upper part of the protective cover 38. The protective cover bottom 40 is rotatably arranged relative to the upper part of the protective cover 38 about a protective cover rotational axis 42.

The upper part of the protective cover 38 is fixedly connected, in particular rotationally fixed, to a housing element of the machine tool 44. The upper part of the protective cover 38 comprises a ramp 32, along which the operating element 22 can be moved for actuating the clamping unit 12. The ramp 32 is mounted on a base body 76 of the upper part of the protective cover 38. It is conceivable that the ramp 32 is configured separately to the base body 76 and is attached to the base body 76, for example by means of a screw connection, a latch connection or the like, or that the ramp 32 is configured integrally with the base body 76. However, it is also conceivable that the upper part of the protective cover 38 is configured free of a ramp 32. The upper part of the protective cover 38 and the lower part of the protective cover 40 at least partly surround the tool holder region 18. The ramp 32 has a contact surface 62 for the operator to place the ball of his hand on when operating the operating element 22. The operating element 22 has a gripping surface 64 for the operator to place his fingers when operating the operating element 22. To release the clamping unit 12, the operating element 22 can be moved from the end position to the fastened state of the clamping unit 12, in particular towards the operating side 36, preferably to the end position of the operating element 22 in the released state of the clamping unit 12.

The lower part of the protective cover 40 can be pivoted between the at least partly open state of the protective cover 16 and the closed state of the protective cover 16 relative to the upper part of the protective cover 38. The guard unit 34 can be actuated depending on the protective cover position, in particular automatically. The guard unit 34 releases actuation of the actuation unit 20 when the protective cover 16, in particular the lower part of the protective cover 40, is closed, preferably automatically. The protective cover position in particular indicates whether the protective cover 16, in particular the lower part of the protective cover 40, is at least partly opened or closed.

Alternatively, it is also conceivable that the guard unit 34 is at least partly electrically formed. For example, it is alternatively conceivable that the guard unit 34 comprises a detection unit for detecting the protective cover position. For example, the detection unit may comprise a mechanical sensor, an optical sensor, or another sensor that appears useful to a person skilled in the art for detecting the protective cover position. It is conceivable that the guard unit 34 comprises a control unit, which is in particular configured to evaluate a signal of the detection unit and, as a function thereof, block or release the actuation unit 20. In particular, the control unit comprises at least one processor and one memory element, as well as an operating program stored on the memory element. The memory element is preferably designed as a digital storage medium, e.g., a hard disk or the like. It is also conceivable that the controller of the guard unit 34 may be formed at least in part by a control unit of the machine tool 44.

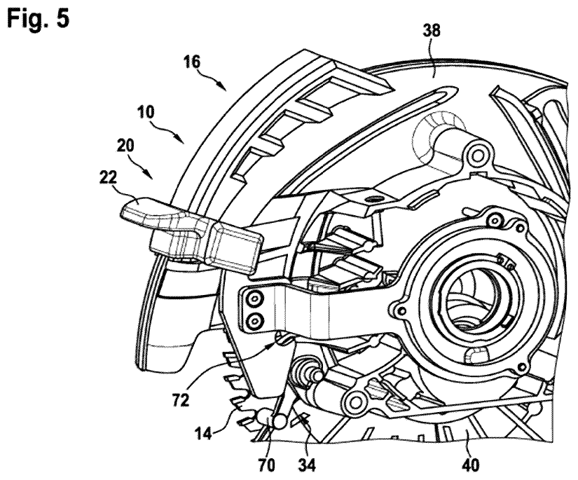

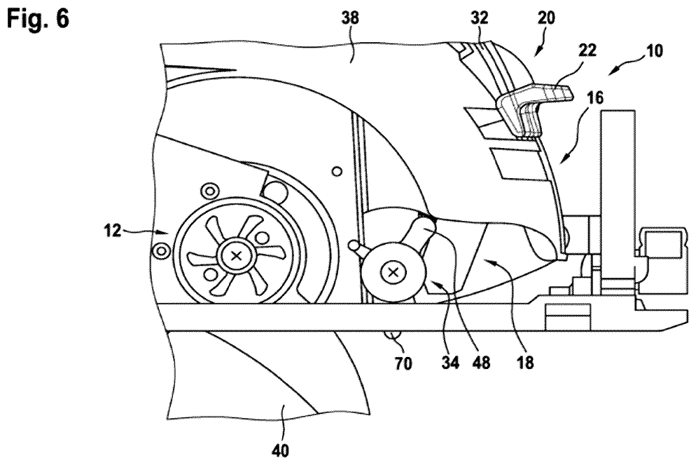

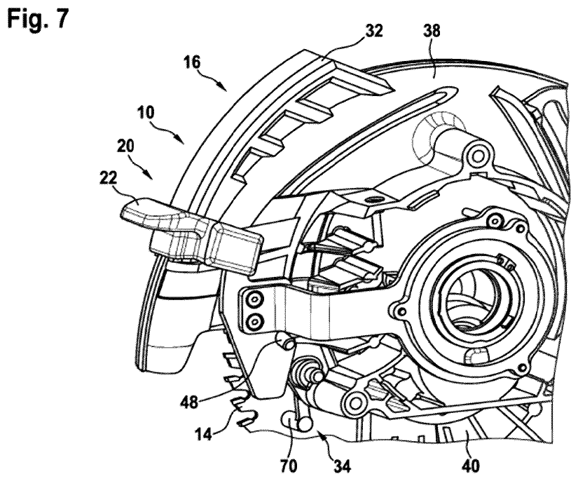

The guard unit 34 comprises a locking element 48. Closing the protective cover 16 moves the locking element 48 to an unlocking position. The locking element 48 is designed as a pin. Alternatively, it is also conceivable that the locking element 48 may be configured as a hook, a ramp-shaped element, or another locking element 48 that may appear useful to those skilled in the art. The actuation unit 20 can be actuated in the unlocked position of the locking element 48. In FIGS. 4 and 5, the locking element 48 is in the unlocked position, wherein the lower part of the protective cover 40 is in particular closed and pushes against a stop pin 70 of the guard unit 34. In the unlocked state, the locking element 48 is in the unlocked position. The operating element 22 can be moved in an unlocked state of the locking element 48 along the protective cover 16, in particular along the upper part of the protective cover 38. The actuation unit 20, in particular the operating element 22, is free of engagement, in particular the application of force, by the guard unit 34, in particular the locking element 48, in the unlocked state of the locking element 48. The guard unit 34 can be actuated by a movement of at least a portion of the protective cover 16, in particular the lower part of the protective cover 40 relative to the guard unit 34, preferably the locking element 48. The locking element 48 can be moved by a movement of the lower part of the protective cover 40. The locking element 48 can be moved from the unlocked state to a locked state and/or from the locked state to the unlocked state by a movement of the at least one portion of the protective cover 16, in particular by a movement of the lower part of the protective cover 40 relative to the guard unit 34, preferably the locking element 48. In the locked state, the locking element 48 is in a locked position. In FIGS. 6 and 7, the locking element 48 is in the locked position, wherein the lower part of the protective cover 40 is at least partly open and the stop pin 70 of the guard unit 34 is free from the application of force by the lower part of the protective cover 40. The locking element 48 can only be moved into the unlocked position when the protective cover 16 is closed. Preferably, the guard unit 34 is designed such that the locking element 48 automatically moves into the locked state when the protective cover 16 is in the open state, for example by means of a gravity-controlled mechanism, by means of a spring element or the like.

The locking element 48 is designed as a pin. The locking element 48 engages in the actuation unit 20 when the protective cover 16 is at least partly open. The locking element 48 acts on the lever arm 60 of the actuation unit 20 when the protective cover 16 is at least partly open. The lever arm 60 has a recess 72 in which the locking element 48 is arranged in the locked state. When the protective cover 16 is at least partly open, the locking element 48 blocks the movement of the operating element 22 along the protective cover 16, in particular the upper part of the protective cover 38. In the locked state, the locking element 48 blocks a movement, in particular a rotation, of the lever arm 60, in particular about the operating element rotational axis 24.

By rotating the locking element 48 about a locking element rotational axis 50, the locking element 48 can be moved into the unlocked position or into the locked position. The guard unit 34, in particular the locking element 48, is rotatably mounted on the protective cover 16, in particular the upper part of the protective cover 38. Alternatively, however, it is also conceivable that the guard unit 34, in particular at least the locking element 48, is rotatably mounted on a housing element of the machine tool 44.

The rotation of the locking element 48 can be generated by a movement of at least a portion of the protective cover 16. The lower part of the protective cover 40 moves the locking element 48 into the unlocked state when the protective cover 16 is closed. The protective cover 16, in particular the lower part of the protective cover 40, is arranged relative to the locking element 48 in such a way that the lower part of the protective cover 40 strikes against the guard unit 34, in particular the stop pin 70, when the protective cover 16 is closed and moves the locking element 48 into the unlocked position. The stop pin 70 is firmly connected, in particular non-rotatably, to the locking element 48. In particular, the stop pin 70 is formed in one piece with the locking element 48. Alternatively, it is also conceivable that the guard unit 34, in particular at least the locking element 48, is mechanically, in particular operatively, preferably directly, connected to the protective cover 16, in particular the lower part of the protective cover 40, irrespective of the protective cover position.

The protective cover rotational axis 42 is spaced apart from and arranged at least essentially parallel to the locking element rotational axis 50 and/or the operating element rotational axis 24. Alternatively, it is also conceivable that the protective cover rotational axis 42 corresponds to the operating element rotational axis 24. The locking element rotational axis 50 is arranged at a distance from and at least essentially parallel to the operating element rotational axis 24.

The protective cover 16 at least partly surrounds the guard unit 34. The guard unit 34, in particular at least the locking element 48, is arranged on a side of the protective cover 16 facing the tool holder region 18. The guard unit 34, in particular at least the locking element 48, is arranged between the upper part of the protective cover 38 and the lower part of the protective cover 40.

1. A machine tool device, comprising:
a clamping unit configured to fix a tool;
a protective cover which at least partly surrounds a tool holder region for the tool; and
an actuation unit configured to actuate the clamping unit; and
a guard unit configured to block the actuation unit when the protective cover is at least partly open.

2. The machine tool device according to claim 1, wherein:
the guard unit comprises a locking element, and
closing the protective cover moves the locking element to an unlocked position.

3. The machine tool device according to claim 1, wherein the guard unit comprises a locking element configured as a pin, which engages in the actuation unit when the protective cover is open.

4. The machine tool device according to claim 1, wherein the guard unit comprises a locking element which is configured to be moved to an unlocked position or a locked position by a rotation about a locking element rotational axis.

5. The machine tool device according to claim 4, wherein the rotation of the locking element is generated by a movement of at least a portion of the protective cover.

6. The machine tool device according to claim 1, wherein the protective cover has at least one upper part of the protective cover and one lower part of the protective cover, which is arranged rotatably relative to the upper part of the protective cover about a protective cover rotational axis.

7. The machine tool device according to claim 4, wherein the protective cover rotational axis is arranged spaced apart from and parallel to the locking element rotational axis.

8. The machine tool device according to claim 1, wherein the actuation unit comprises an operating element which is at least partly moved along the protective cover for actuation.

9. The machine tool device according to claim 8, wherein:
the operating element is configured to be moved about an operating element rotational axis, and
a movement of the operating element about the operating element rotational axis generates a movement of an actuating element of the clamping unit which runs parallel to the operating element rotational axis.

10. The machine tool device according to claim 6, wherein the protective cover rotational axis is arranged spaced apart from and parallel to the operating element rotational axis.

11. The machine tool device according to claim 4, wherein the locking element rotational axis is arranged spaced apart from and parallel to the operating element rotational axis.

12. The machine tool device according to claim 1, wherein the protective cover at least partly surrounds the guard unit.

13. A machine tool comprising a machine tool device according to claim 1.

14. A system, comprising a tool and a machine tool according to claim 13.

15. The machine tool device according to claim 1, wherein:
the machine tool device is a circular saw device, and
the tool is a circular saw blade.
